(19) United States
(12) Patent Application Publication
(10) Pub. No.: US 2018/0044981 A1
(43) Pub. Date: Feb. 15, 2018

(54) CURTAIN CONTROLLER

(71) Applicant: Haifeng WANG, YuYao City, Zhejiang (CN)

(72) Inventor: Haifeng WANG, YuYao City, Zhejiang (CN)

(21) Appl. No.: 15/532,627

(22) PCT Filed: Jan. 20, 2017
(86) PCT No.: PCT/CN2017/071945

§ 371 Date: Jun. 2, 2017

(30) Foreign Application Priority Data
Feb. 4, 2016 (CN) 201610080029.4

(51) Int. Cl. E06B 9/78; E06B 9/58

(52) U.S. Cl. CPC E06B 9/78; E06B 9/58; E06B 2009/785

(57) ABSTRACT

The invention discloses a curtain controller comprising a cover plate, a housing, a clutch head, a clutch device, a pushing device and a pull rope; wherein the pull rope drives the pushing device for forward movement to push the clutch device to be engaged with the clutch head; and after the pull rope is released, the pushing device moves backward to drive the clutch device to be disengaged with the clutch head and the pull rope is wound onto the pushing device. The curtain controller of the invention has a simple structure and few parts and components to reduce the production cost, and provides simple operation to facilitate maintenance and replacement when a fault occurs.

### FIELD OF THE INVENTION

The invention relates to the field of curtain control fittings, and particularly to a controller for controlling the automatic falling of a curtain.

### BACKGROUND OF THE INVENTION

There are various types of curtain structures on the market, for example, shutters, blinds, roman curtains and the like, which are generally mounted at places such as household doors and windows to achieve the functions of sunlight shielding and decoration. When an existing curtain controller moves up and down, a ball rope needs to be continuously pulled until a curtain rises up and falls down, especially in the falling process, the curtain falls quickly due to its gravity, thus the curtain is bound to be damaged if the falling speed of the curtain is not controlled by an upward traction force.

To overcome the above problem, a roller blind controller has been designed commercially, the details of which are seen in Patent Document Authorization Announcement No. CN 202731710 U. A roller blind controller comprises a sleeve cover, a bushing, a positioning block, a pull rope sleeve wheel and an outer sleeve cover; wherein the sleeve cover comprises a concave accommodating space and a limiting rod protruding from the center of an inner face of the accommodating space; clamping slots for positioning the bushing are arranged at two sides of an end of the limiting rod; the bushing comprises a disc surface having a central perforation, a joining portion extending from a side end face of the disc surface, and clamping blocks which are correspondingly projecting from two sides of the central perforation so as to be sleeved on the limiting rod and be correspondingly fixedly clamped with the clamping slots at the end of the limiting rod; the joining portion is joined with the pull rope sleeve wheel, such that a gap in which the pull rope sleeve wheel and the sleeve cover do not contact with each other is foamed therebetween by the bushing; the positioning block is arranged at a front end of the limiting rod of the sleeve cover, and comprises a body and an insertion slot which is longitudinally annularly arranged at a periphery of the body so as to be correspondingly embedded with an insert disposed in the outer sleeve cover to achieve positioning and joining; and the support of the positioning block prevents a central axis of the limiting rod from deflecting due to the gravity of a roller blind, and the roller blind is pulled up and down more smoothly.

Upon analysis of the above scheme, it is not difficult to find that the above structure can control a roller blind to be rolled and withdrawn up and down, but has the following defects: (1) the controller has a complex structure, high production cost and a complex assembling process; (2) many parts and components require much cooperation during use, thus a mechanical failure easily occurs at a position in need of cooperation after long-time use; (3) many parts and components also cause another problem, i.e. it is very inconvenient to repair and debug the roller blind controller when a mechanical failure occurs; and (4) a pull rope is so long that children are easily wound at their necks to cause tragedy when playing out of curiosity.

### SUMMARY OF THE INVENTION

To overcome the disadvantages existing in the prior art, the invention provides a curtain controller for controlling the rising or falling of a curtain, which has a simple structure and simplified parts and components.

To achieve the above object, the invention employs the following technical solution: a curtain controller comprises a cover plate and a housing; wherein the cover plate is connected with the housing to form a cavity; and further comprises a clutch head, a clutch device, a pushing device and a pull rope; wherein a positioning table is arranged at a middle part of the clutch head; the positioning table is provided with an annular slot; the clutch head is capable of rotating freely on the housing by cooperation between a clamping ring clamped on the annular slot and the positioning table; toothed chutes evenly distributed around an axis are arranged at a tail part of the clutch head; the pushing device and the clutch device are arranged in the cavity; the clutch device comprises a connecting shaft and a guide pulley; the connecting shaft is sleeved in the guide pulley; chutes cooperating with the toothed chutes of the clutch head are arranged at the top of the guide pulley; one end of the pull rope is wound on the pushing device and the other end thereof passes through a rope outlet arranged on the housing to extend outside the housing; the pull rope drives the pushing device for forward movement to push the clutch device to be engaged with the clutch head; and after the pull rope is released, the pushing device moves backward to drive the clutch device to be disengaged with the clutch head and the pull rope is wound onto the pushing device.

The operating principle of the invention is as follows: a clutch head is connected with a winding shaft of a curtain, a pull rope is rapidly pulled when the curtain needs falling, a pushing device moves forward to push a guide pulley of a clutch device to be rapidly engaged with the clutch head, and the clutch head drives the winding shaft of the curtain connected therewith to rotate; and after the pull rope is released, the pushing device moves backward to drive the guide pulley to be disengaged with the clutch head and the pull rope is wound onto the pushing device. The curtain falls slowly under gravity to realize the effects of sunlight blocking and decoration. In the falling process of the curtain, if falling needs to be stopped, the pull rope can be pulled again such that the guide pulley is engaged with the clutch head again; and the clutch head prevents the curtain from continuing to fall, and the curtain stops at any position required by a user. After the pull rope is released, the pushing device moves backward to drive the guide pulley to be disengaged with clutch head and the pull rope is wound onto the pushing device. When the curtain needs to be pulled up again, the pull rope is pulled continuously such that the pushing device rotates forward, and the pushing device pushes the guide pulley to be rapidly pushed axially, thus realizing the cooperation between the guide pulley and the clutch head. Since the pushing device continuously rotates forward under the acting force of the pull rope, the guide pulley and the clutch head remain in an engaged state; and the clutch head drives the winding shaft of the curtain to rotate, and then the curtain is pulled up. After the rope pulling operation of the curtain is completed, the pull rope is released, the pushing device rotates backward to drive the guide pulley to be disengaged with clutch head and the pull rope is wound onto the pushing device.

A roller blind controller made by employing the technical solution of the invention has the following advantages: (1) a simple structure and few parts and components are used, thus reducing the production cost and improving the processing efficiency; (2) simple operation is provided and cooperation is relatively little, thus facilitating maintenance and replacement when a fault occurs; and (3) adults can reach a pull rope just by raising their hands, thus children are prevented from tying their necks when playing with the pull rope.

A further improvement is that the pushing device comprises a rope disc, a spiral spring and a guide shaft; an annular boss is arranged at a central area of an inner side of the cover plate, a fixing shaft is arranged at a central position of the annular boss and the fixing shaft is provided with a clamping slot; the rope disc is internally provided with a chamber; a winding slot is arranged on an outer wall of the rope disc; protrusions for limiting the guide pulley from sliding out of the rope disc during rotation are arranged at the top of the rope disc; a starting point of the spiral spring is clamped at a position of the fixing shaft near the cover plate by the clamping slot; the coiled spiral spring is placed in the chamber of the rope disc; and one end of the guide shaft is fixed at the top of the fixing shaft and the other end thereof is sleeved with the connecting shaft. After the above design is adopted, the pull rope is pulled to drive the rotation of the rope disc and the spiral spring is tensioned to accumulate force, and after the pull rope is released, the rope disc rotates backward to withdraw the pull rope when driven by the spiral spring; and meanwhile the rope disc drives the guide pulley to move axially, thus realizing the cooperation between the guide pulley and the clutch head to manipulate the curtain.

A side wall of the guide pulley is provided with two symmetrical track slots which are inclined downward from the top; the protrusions are symmetrically distributed; and the protrusions cooperate with the track slots to limit the guide pulley from sliding out of the rope disc. After the above design is adopted, the protrusions slide in the track slots due to a certain friction produced after the connecting shaft and the guide pulley are assembled, thus allowing the guide pulley to move axially. The cooperation between the track slots and the protrusions ensures the stability of the guide pulley during its axial movement, thus improving the cooperation between the guide pulley and the clutch head, and reducing the failure rate of the curtain controller during use.

A further improvement is that a disc-shaped base is arranged at the bottom of the guide shaft. The design of the disc-shaped base can allow the spiral spring to be pressed down, thus preventing the spiral spring from moving axially during pulling.

A further improvement is that a circular table is arranged at the bottom of the connecting shaft; the connecting shaft is internally provided with bar-shaped protrusions evenly distributed around a central axis; the guide shaft is provided with bar-shaped recesses cooperating with the bar-shaped protrusions; a limiting table is arranged at the top of the guide pulley; a clamping tongue is arranged at the bottom of the guide pulley; and the connecting shaft is clamped inside the guide pulley by cooperation between the limiting table and the clamping tongue. The connecting shaft cooperates with the guide shaft by the bar-shaped protrusions and the bar-shaped recesses such that the connecting shaft and the guide shaft can move simultaneously in the same direction as a whole.

A further improvement is that an anti-skid slot is arranged at a position symmetrical to the clamping tongue inside the guide pulley; and the anti-skid slot is internally provided with a friction-enhancing gasket. The design of the gasket enhances the friction between the guide pulley and the connecting shaft such that their consistency can be ensured in the moving process of the guide pulley.

A further improvement is that the curtain controller further comprises a pull rope guide buckle; wherein the pull rope guide buckle is internally provided with a rope guiding hole, and provided with clamping blocks at two sides thereof; and the pull rope guide buckle is fixed on the rope outlet of the housing by the clamping blocks. The design of the rope guiding hole mainly acts to adjust the pull rope to be parallel, thus facilitating the pull rope to be pulled out and withdrawn freely.

### BRIEF DESCRIPTION OF THE DRAWINGS

FIG. 1 is a schematic exploded view of a curtain controller;

FIG. 2 is a first partial schematic exploded view of the curtain controller; and

FIG. 3 is a second partial schematic exploded view of the curtain controller.

In the Figures: 1. cover plate; 2. housing; 3. clutch head; 4. clamping ring; 5. connecting shaft; 6. guide pulley; 7. rope disc; 8. spiral spring; 9. guide shaft; 10. pull rope guide buckle; 11. annular boss; 12. fixing shaft; 21. rope outlet; 31. positioning table; 32. annular slot; 33. toothed chute; 51. circular table; 52. bar-shaped protrusion; 61. chute; 62. track slot; 63. limiting table; 64. clamping tongue; 65. anti-skid slot; 71. chamber; 72. winding slot; 73. protrusion; 74. annular slot; 75. first notch; 76. second notch; 77. opening; 91. disc-shaped base; 92. bar-shaped recess; 93. raised bar; 101. rope guiding hole; 102. clamping block; 121. clamping slot.

### DETAILED DESCRIPTION OF THE INVENTION

A preferred embodiment of the invention will be further described below with reference to the accompany drawings.

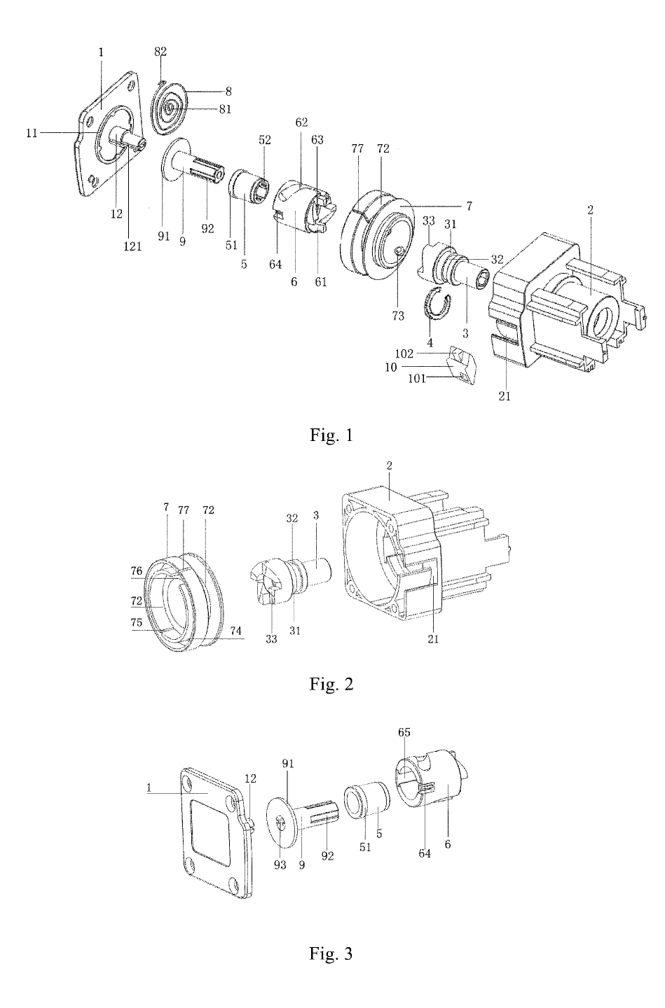

As shown in FIGS. 1 to 3, a curtain controller comprises a cover plate 1, a housing 2, a clutch head 3 connected with a winding shaft of a curtain, a clutch device, a pushing device, a pull rope and a pull rope guide buckle 10; wherein the cover plate is fixedly connected with the housing via screws, and the cover plate is connected with the housing to form a cavity.

An annular boss 11 is arranged at a central area of an inner side of the cover plate 1, the annular boss 11 is designed to prevent the rope disc from swinging during pulling, a fixing shaft 12 is arranged at a central position of the annular boss 11 and the fixing shaft 12 is provided with a clamping slot 121; and the clamping slot 121 extends all the way to the bottom of the fixing shaft from the top of the fixing shaft 12 such that the fixing shaft 12 is divided into two parts.

A positioning table 31 is arranged at a middle part of the clutch head 3; the positioning table is provided with an annular slot 32; the clutch head 3 is capable of rotating freely on the housing by cooperation between a clamping ring 4 clamped on the annular slot 32 and the positioning table; and toothed chutes 33 evenly distributed around an axis are arranged at a tail part of the clutch head 3.

The pushing device and the clutch device are arranged in the cavity.

The clutch device comprises a connecting shaft 5 and a guide pulley 6. A circular table 51 is arranged at the bottom of the connecting shaft 5; and the connecting shaft is internally provided with bar-shaped protrusions 52 evenly distributed around a central axis. Chutes 61 cooperating with the toothed chutes 33 of the clutch head 3 are arranged at the top of the guide pulley 6; a side wall of the guide pulley 6 is provided with two symmetrical track slots 62 which are inclined downward from the top; a limiting table 63 is arranged at the top of the guide pulley 6; a clamping tongue 64 is arranged at the bottom of the guide pulley; an anti-skid slot 65 is arranged at a position symmetrical to the clamping tongue inside the guide pulley 6; and the anti-skid slot is internally provided with a friction-enhancing gasket. The connecting shaft 5 is sleeved inside the guide pulley 6 by cooperation between the limiting table 63 and the clamping tongue 64.

The pushing device comprises a rope disc 7, a spiral spring 8 and a guide shaft 9. The rope disc 7 is internally provided with a chamber 71; a winding slot 72 is arranged on an outer wall of the rope disc 7; protrusions 73 for limiting the guide pulley from sliding out of the rope disc during rotation are arranged at the top of the rope disc; and the protrusions 73 are two symmetrically distributed protrusions. The protrusions 73 cooperate with the track slots 62 to limit the guide pulley 6 from sliding out of the rope disc. An annular slot 74 is also arranged between the chamber 71 and a housing of the rope disc; and a first notch 75 and a second notch 76 are arranged between a side wall of the annular slot and the chamber, wherein the first notch 75 is used for clamping an end point of the spiral spring and the second notch 76 is used for clamping a starting point of the pull rope. An opening 77 through which the pull rope can pass is arranged between an outer side wall of the annular slot 74 and the winding slot. A starting point 81 of the spiral spring 8 is clamped at a position of the fixing shaft 12 near the cover plate 1 by the clamping slot 121; the coiled spiral spring 8 is placed in the chamber of the rope disc 7; and an end point 82 of the spiral spring is clamped at the first notch 75 of the rope disc. A disc-shaped base 91 is arranged at the bottom of the guide shaft 9, and the design of the disc-shaped base can allow the spring to be pressed down, which prevents axial movement and also can prevent the guide shaft from sliding out of the rope disc. The guide shaft 9 is provided with bar-shaped recesses 92 cooperating with the bar-shaped protrusions 52 of the connecting shaft 5. A through hole fixedly clamped with the fixing shaft 12 is arranged on a central axis of the guide shaft; two symmetrical raised bars 93 are arranged on the through hole; and the raised bars 53 just can be clamped in the clamping slot 121 of the fixing shaft 12 when one end of the guide shaft 9 is connected with the top of the fixing shaft 12. The other end of the guide shaft is sleeved with the connecting shaft 5 by cooperation between the bar-shaped protrusions 52 and the bar-shaped recesses 92. The housing 2 is provided with a rope outlet 21; the pull rope guide buckle 10 is internally provided with a rope guiding hole 101, and provided with clamping blocks 102 at two sides thereof; and the pull rope guide buckle is fixed on the rope outlet 21 of the housing by the clamping blocks. The starting point of the pull rope is fixedly clamped by the second notch 76, then passes through the opening of the rope disc and then is wound onto the winding slot of the rope disc; and the other end of the pull rope passes through the rope guiding hole 101 of the pull rope guide buckle 10 to extend outside the housing. The pull rope drives the rope disc of the pushing device for forward movement to push the guide pulley of the clutch device to be engaged with the clutch head; and after the pull rope is released, the pushing device moves backward to drive the clutch device to be disengaged with the clutch head and the pull rope is wound onto the pushing device.

When a roller blind controller is assembled, the guide shaft 9 first passes through the guide pulley 6 and then is placed inside the rope disc 7, protrusions 33 of the rope disc 3 need to slide into the track slots 62 at an outer side of the guide pulley during placement, and then the wound spiral spring 8 is placed in the chamber of the rope disc 7, wherein the end point 82 of the spiral spring 8 is clamped on the first notch 75; and then the starting point 81 of the spiral spring 8 is clamped in the clamping slot 121 of the fixing shaft 12 of the cover plate. The clutch head 3 passes through the housing 2, and the clutch head is clamped with the housing by the clamping ring 4. After connection, the clutch head 3 is tested by rotation to ensure that the clutch head is capable of rotating freely around an axis on the housing 2. One end of the pull rope is twisted into a joint, then placed in the second notch 76 and then wound onto the winding slot through the opening 77. The other end of the pull rope passes through the rope guiding hole 101 of the pull rope buckle 10, and then the pull rope buckle 10 is clamped at the rope outlet 21 of the housing by the clamping blocks. Subsequently, the housing is fixedly connected with the cover plate via screws. Finally, the curtain controller is mounted at a corresponding position to control the curtain.

1. A curtain controller, comprising a cover plate (1) and a housing (2); the cover plate being connected with the housing to form a cavity; and further comprising a clutch head (3), a clutch device, a pushing device and a pull rope; a positioning table (31) being arranged at a middle part of the clutch head (3); the positioning table being provided with an annular slot (32); the clutch head (3) being capable of rotating freely on the housing by cooperation between a clamping ring (4) clamped on the annular slot (32) and the positioning table; toothed chutes (33) evenly distributed around an axis being arranged at a tail part of the clutch head (3); the pushing device and the clutch device being arranged in the cavity; the clutch device comprising a connecting shaft (5) and a guide pulley (6); the connecting shaft (5) being sleeved in the guide pulley (6); chutes (61) cooperating with the toothed chutes of the clutch head being arranged at the top of the guide pulley (6); one end of the pull rope being wound on the pushing device and the other end thereof passing through a rope outlet (21) arranged on the housing (2) to extend outside the housing; the pull rope driving the pushing device for forward movement to push the clutch device to be engaged with the clutch head; after the pull rope is released, the pushing device moving backward to drive the clutch device to be disengaged with the clutch head and the pull rope being wound onto the pushing device; the pushing device comprising a rope disc (7), a spiral spring (8) and a guide shaft (9); an annular boss (11) being arranged at a central area of an inner side of the cover plate (1), a fixing shaft (12) being arranged at a central position of the annular boss (11) and the fixing shaft (12) being provided with a clamping slot (121); the rope disc (7) being internally provided with a chamber (71); a winding slot (72) being arranged on an outer wall of the rope disc (7); protrusions (73) for limiting the guide pulley from sliding out of the rope disc during rotation being arranged at the top of the rope disc; a starting point of the spiral spring (8) being clamped at a position of the fixing shaft (12) near the cover plate (1) by the clamping slot (121); the coiled spiral spring (8) being placed in the chamber of the rope disc (7); and one end of the guide shaft (9) being fixed at the top of the fixing shaft (12) and the other end thereof being sleeved with the connecting shaft (5).

2. The curtain controller according to claim 1, wherein a side wall of the guide pulley (6) is provided with two symmetrical track slots (62) which are inclined downward from the top; the protrusions (73) are symmetrically distributed; and the protrusions (73) cooperate with the track slots (62) to limit the guide pulley (6) from sliding out of the rope disc.

3. The curtain controller according to claim 1, wherein a disc-shaped base (91) is arranged at the bottom of the guide shaft (9).

4. The curtain controller according to claim 1, wherein a circular table (51) is arranged at the bottom of the connecting shaft (5); the connecting shaft is internally provided with bar-shaped protrusions (52) evenly distributed around a central axis; the guide shaft (9) is provided with bar-shaped recesses (92) cooperating with the bar-shaped protrusions; a limiting table (63) is arranged at the top of the guide pulley (6); a clamping tongue (64) is arranged at the bottom of the guide pulley; and the connecting shaft (5) is clamped inside the guide pulley (6) by cooperation between the limiting table and the clamping tongue.

5. The curtain controller according to claim 3, wherein an anti-skid slot (65) is arranged at a position symmetrical to the clamping tongue inside the guide pulley; and the anti-skid slot is internally provided with a friction-enhancing gasket.

6. The curtain controller according to claim 1, further comprising a pull rope guide buckle (10); the pull rope guide buckle being internally provided with a rope guiding hole (101), and provided with clamping blocks (102) at two sides thereof; and the pull rope guide buckle being fixed on the rope outlet (21) of the housing by the clamping blocks.
